(19) United States
(12) Patent Application Publication
(10) Pub. No.: US 2007/0187925 A1
(43) Pub. Date: Aug. 16, 2007

(54) Self-adjusting fifth wheel trailer and hitch assembly

(76) Inventors: Thomas W. Lindeman, South Bend, IN (US); David L. Hoover, Sturgis, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/502,697

(22) Filed: Aug. 11, 2006

Related U.S. Application Data
(60) Provisional application No. 60/707,313, filed on Aug. 11, 2005.

(51) Int. Cl. B62D 53/06

(52) U.S. Cl. 280/438.1

(57) ABSTRACT

An apparatus for coupling a trailer to a transporting vehicle is provided. The apparatus has a trailer assembly coupled to a hitch assembly. The trailer assembly has a skid plate having a cam channel formed therein and a cam arm having a cam member wherein the cam member engages and is movable within the cam channel. A hitch bar pivotally connects the hitch assembly to the trailer assembly. The trailer assembly is slidable in a longitudinal direction with respect to the hitch assembly such that the trailer is movable toward and away from the towing vehicle. To this end, the hitch assembly is mountable in a stationary position with respect to the vehicle and the trailer assembly is movable away from the transporting vehicle.

### CROSS-REFERENCE TO RELATED APPLICATION

This application claims priority from U.S. Provisional Patent Application No. 60/707,313 filed on Aug. 11, 2005, which is hereby incorporated by reference.

### BACKGROUND

The present invention relates generally to fifth wheel trailer and hitch assemblies for use on pickup trucks and similar vehicles used to tow fifth wheel trailers, and particularly to a self-adjusting fifth wheel trailer assembly.

Fifth wheel trailers and hitches are well known in the art. Fifth wheel trailers are generally much larger and heavier than typical trailers and often require relatively heavy tow vehicles such as heavy-duty pickup trucks to pull them. Generally, a fifth wheel trailer assembly (pinbox and kingpin) is mounted to the fifth wheel trailer and a fifth wheel hitch assembly (fifth wheel support and locking mechanism) is mounted to the flatbed of a pickup truck. Thus, the kingpin of the pinbox engages the locking jaw mechanism of the fifth wheel to pivotally engage the trailer to the towing vehicle. The fifth wheel trailer is thus able to pivot relative to the tow vehicle about a vertical axis to facilitate cornering and parking. Normally, the fifth wheel hitch assembly is mounted directly over or a short distance in front of the rear axle of the tow vehicle in order to maintain proper weight distribution. Thus, when the fifth wheel trailer assembly engages the fifth wheel hitch assembly, a portion of the trailer's weight is carried directly over the rear axle of the tow vehicle.

So as to permit the turning of the towing vehicle and relative pivoting between the towing vehicle and the trailer, there must be at least 51 inches of clearance between the pivot point and the rear of the towing vehicle cab in order to prevent contact between the trailer and the cab (sometimes more depending on the fore/aft location of the pivot pin relative to the front of the trailer). Recently, there has been a consumer trend towards extending pickup truck cabs. These trucks have greatly expanded interior cargo volume and also have specially designed rear jump seats for accommodating additional passengers. Unfortunately, most of these extended cab pickups are built on a standard wheelbase chassis because consumers prefer the driving characteristics of a shorter truck, and accordingly, the bed of these trucks is typically 6 feet long rather than 8 feet long. Although these shorter bed pickups have the towing capacity to handle fifth wheel trailers, they do not have enough clearance between the axle and the rear of the cab to allow the trailer to pivot to a 90-degree angle without contacting the cab, which could damage the truck and severely injure any occupants. In most circumstances, a fifth wheel trailer will contact the cab of a short bed pickup at angles much less than 90 degrees.

Several approaches have been contemplated to adapt fifth wheel trailers to short bed pickup trucks. One particular approach uses a sliding fifth wheel hitch base that requires the operator to exit the truck, unlock the base, lock the brakes on the trailer and pull the truck forward. This temporarily moves the pivot point rearward in the truck bed so that the trailer can pivot relative to the truck to a certain extent without contacting the cab. However, before resuming driving, the driver must lock the trailer brakes, back the truck towards the trailer, again exit the truck and lock the sliding hitch, and return to the truck. Obviously, such a system is impractical in many situations, such as negotiating sharp turns in traffic, and is practically useless in an emergency.

Another approach involves providing a self-adjusting, sliding hitch assembly as described in U.S. Pat. No. 6,308,977 issued to Andrew Pulliam, et al. on Oct. 30, 2001, and entitled Sliding Hitch for Fifth Wheel Trailers which is hereby explicitly incorporated by reference herein. However, the '977 patent merely describes and contemplates providing a fifth wheel hitch assembly mounted to the vehicle bed that includes a “head” slidable relative thereto. As such, a larger fifth wheel hitch assembly must be constructed to provide sliding movement. Further, as with the prior art, such sliding movement of the fifth wheel hitch assembly head moves the weight distribution of the fifth wheel trailer longitudinally along the vehicle and out of alignment with the rear axle of the vehicle. As a result, the fifth wheel trailer places increased forces on the chassis of the towing vehicle and the fifth wheel hitch.

Thus, there is a need to address the problems associated with the disadvantages of the prior art. As such, the present invention overcomes these disadvantages by providing the sliding movement in the fifth wheel trailer assembly thereby allowing the fifth wheel hitch assembly to be stationarily mounted within the pickup bed. As such, the most efficient or appropriate position for the fifth wheel hitch assembly can be determined and utilized so as to provide an ideal position for accommodation of the weight thereon. In addition, the ideal position can be maintained even during automatic adjustment.

### SUMMARY OF THE INVENTION

Therefore, disclosed herein, is a fifth wheel assembly for coupling a trailer to a vehicle, the fifth wheel assembly comprising a trailer assembly engagable with a hitch assembly. The trailer assembly has a skid plate having a cam channel formed therein and a cam arm having a cam member wherein the cam member engages and is movable within the cam channel. A hitch bar may pivotally connect the hitch assembly to the trailer assembly. The hitch assembly may have a base attachable to a transporting vehicle and a rocker pivotally connected to the base. The trailer assembly is slidable in a longitudinal direction with respect to the hitch assembly such that the trailer is movable toward and away from the towing vehicle. To this end, the hitch assembly may be mounted in a stationary position with respect to the vehicle and the trailer assembly may slide away from the vehicle.

### BRIEF DESCRIPTION OF THE SEVERAL VIEWS OF THE DRAWING

Objects and advantages together with the operation of the invention may be better understood by reference to the following detailed description taken in connection with the following illustrations, wherein:

FIG. 1 is a perspective view of the present invention.

FIG. 2 is a perspective view of the hitch assembly utilized with the present invention.

FIG. 3 is a perspective view of the trailer assembly of the present invention.

FIGS. 4 is a bottom plan view of the trailer assembly of FIG. 3.

FIGS. 5 is a perspective view as seen from the bottom of the trailer assembly of FIG. 3.

FIGS. 6 is a side elevational view of the trailer assembly of FIG. 3.

FIGS. 7a through 7e are several views of sliding component of the present invention.

FIGS. 8 is bottom perspective view of the sliding component when the towing vehicle is moving in the straightforward direction.

FIGS. 9 is a bottom plan view of the sliding component when the towing vehicle takes a hard right turn.

FIGS. 10 is a bottom plan view of the sliding component when the towing vehicle takes a hard left turn.

### DETAILED DESCRIPTION OF THE INVENTION

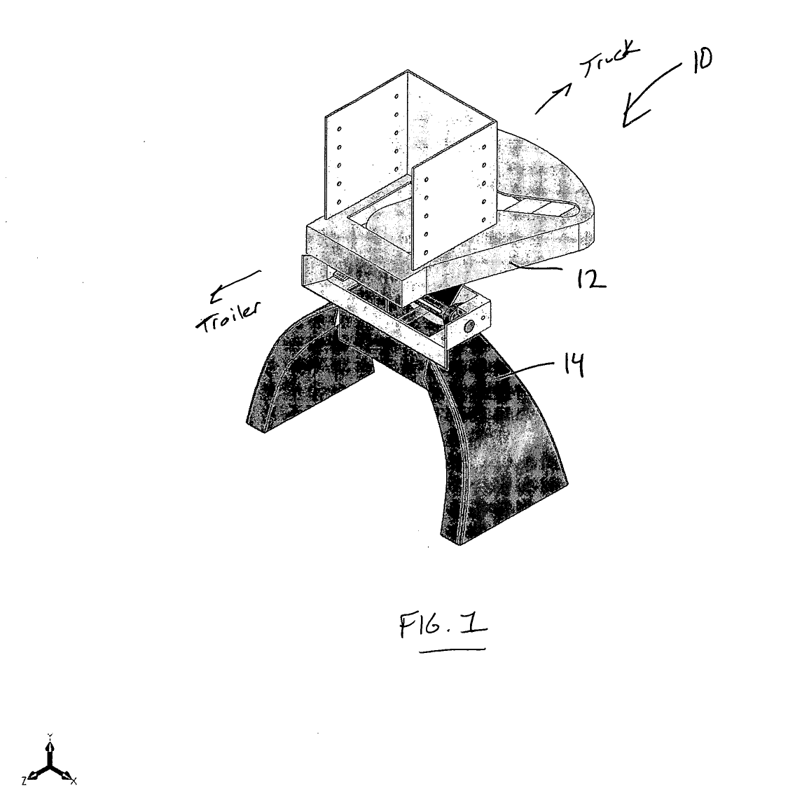

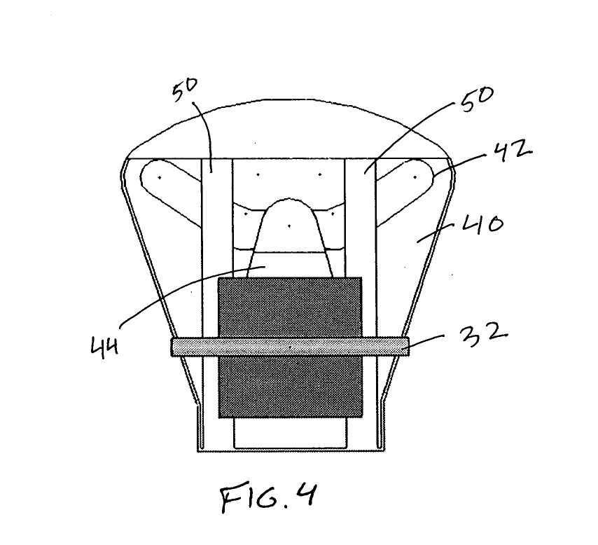

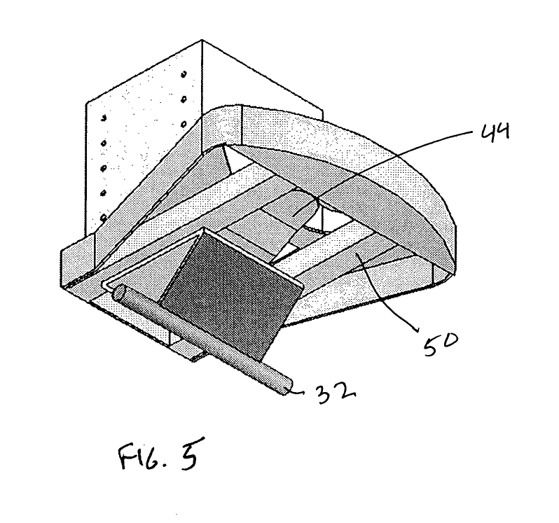

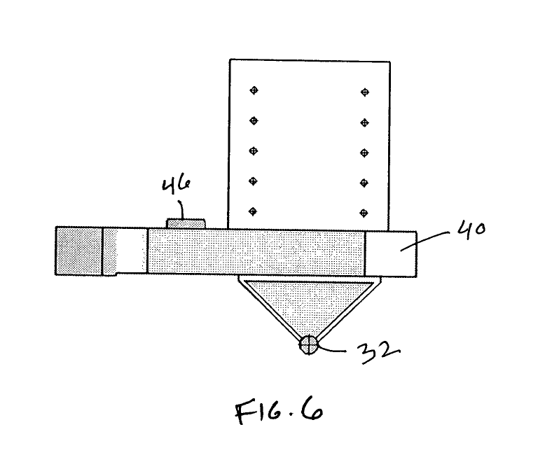

The present invention will now be described in accordance with the preferred embodiment as shown in FIGS. 1 through 10. However, it will be appreciated that modifications and alternative designs could be utilized upon reading and understanding the detailed description and still be within the scope of the invention as contemplated. As such, the following description is presented by way of illustration only and should not limit in any way the various alternatives and modifications that may be made to the illustrated embodiment and still be within the spirit and scope of the invention.

As shown in FIG. 1, the present invention is directed to a sliding fifth wheel trailer and hitch assembly, generally indicated by the reference numeral 10, and comprising a sliding fifth wheel trailer assembly 12 and a fifth wheel hitch assembly 14 so that the pickup truck and trailer (not shown) can pivot relative to each other about a pivot point.

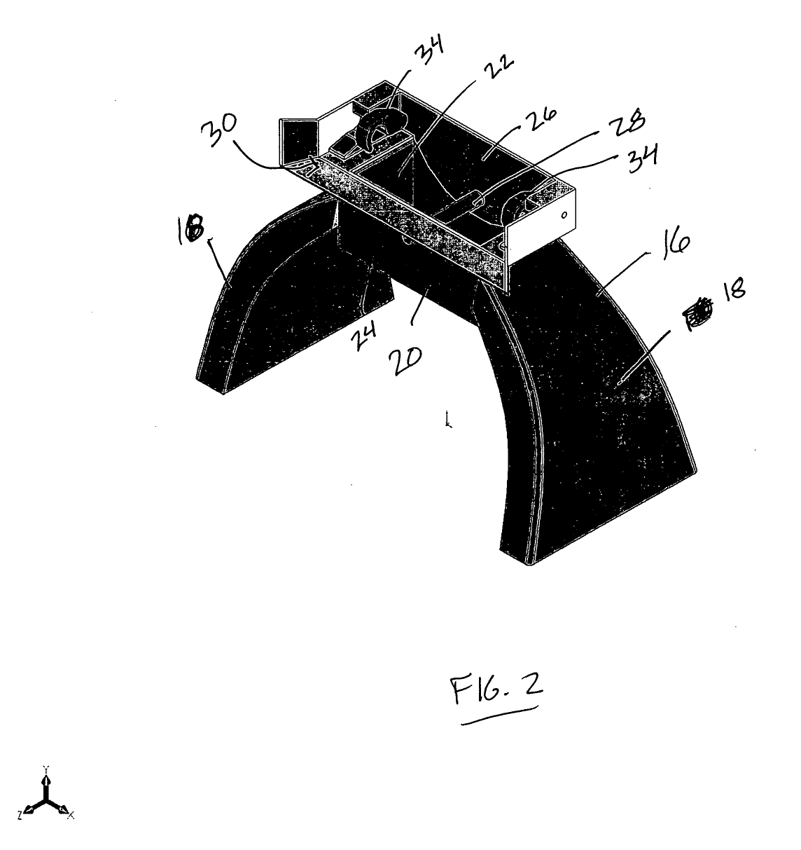

As best shown in FIG. 2, the hitch assembly 14 comprises a base 16 attachable to the bed of a pickup truck (not shown) according to common industry practice. Preferably, the hitch assembly 14 is mounted within the bed of the vehicle over the rear axle of the vehicle and secured to the frame of the vehicle through apertures in the bed. The base 16 is of modular configuration and comprises first and second legs 18 and a central housing 20. Further, the central housing 20 includes first and second end walls 22 and first and second sidewalls 24. A rocker 26 is pivotally connected to the central housing 22. In particular, the rocker 26 pivots about a pivot pin or trunnion 28. As a result of this arrangement, the rocker 26 pivots freely from side to side with respect to the central housing 20.

The rocker 26 general comprises a box-like structure having an opening 30 that assists in the insertion of the hitch bar 32, described in greater detail below. Within the rocker 26 is a pair of latch members 34 to pivotally capture the hitch bar 32 of the trailer assembly 12 to secure the hitch bar 32 firmly to the base 16 thus securing the trailer to the pickup truck. However, it should be clear that other suitable known connections could be made to connect the trailer assembly to the hitch assembly as well as permit pivoting thereabout.

The sidewalls of the central housing 24 each include a series of spaced mounting points (not shown) as know in the art. Fasteners in the form of bolts are utilized to secure the legs 18 to the sidewalls 24 of the central housing 20. More particularly, the bolts are inserted through any one set of the series of vertically spaced mounting apertures and threadedly engaged in the apertures in the inner section or mounting walls of the legs. As should be appreciated, the height of the central housing 20 relative to the legs 18 may be adjusted depending upon which set of the series of vertically spaced mounting apertures is selected to complete the connection.

The legs 18 preferably are arched and have a radius of curvature of between about 17 to about 21 degrees and typically about 19 degrees. The radius of curvature may be constant or may vary over the length of the legs 18. The arched legs 18 define an arc of between about 45 to about 90 degrees and typically about 60 degrees. Advantageously, the arched legs 18 provide not only added strength but also better and more favorable distribution of the trailer weight across the fifth wheel hitch assembly 14 and the towing vehicle (i.e., provides optimum vertical down strength). Further, the arched configuration of the legs 18 delivers loads efficiently through the vehicle frame in a more direct path.

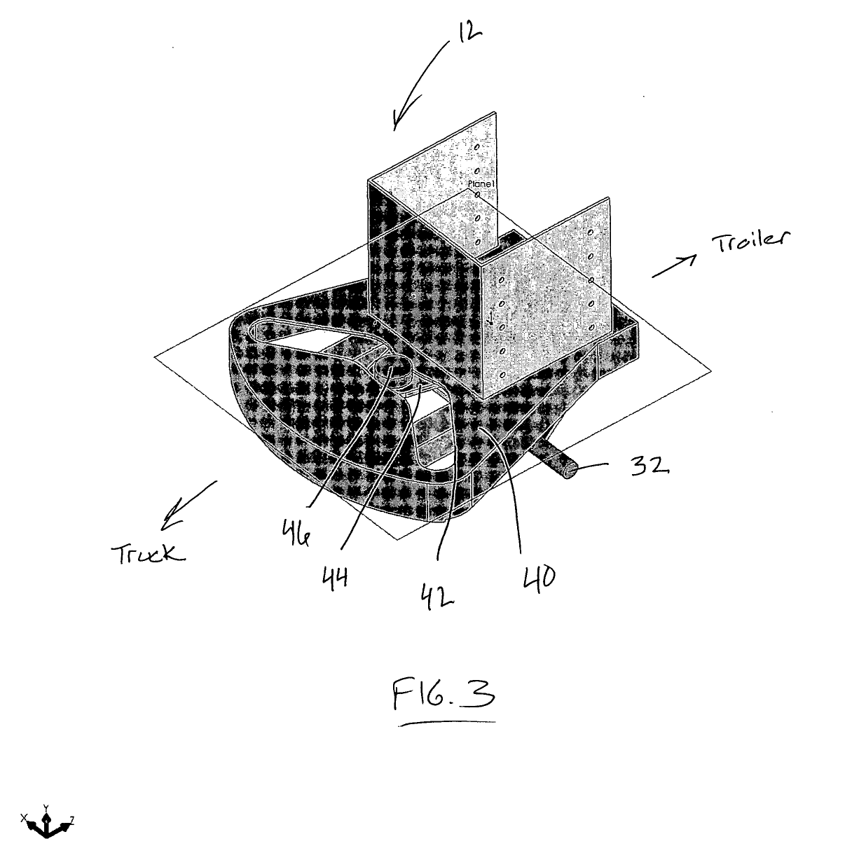

The sliding fifth wheel trailer assembly 12, as best shown in FIG. 3, is removably and pivotally connected to the fifth wheel hitch assembly 14 by hitch bar 32. The sliding trailer assembly 12 according to the present invention allows the trailer assembly 12, and thus the trailer connected thereto, to slide relative to the hitch bar 32 in a direction away from the truck cab. As such, the trailer moves relative to the hitch bar 32 while the hitch bar 32 continuously engages the hitch assembly 14 at the mounting point (i.e. hitch bar 32 engagement with the latch members 34), typically directly over, or in some circumstances slightly in front of, the centerline of the truck axle (not shown).

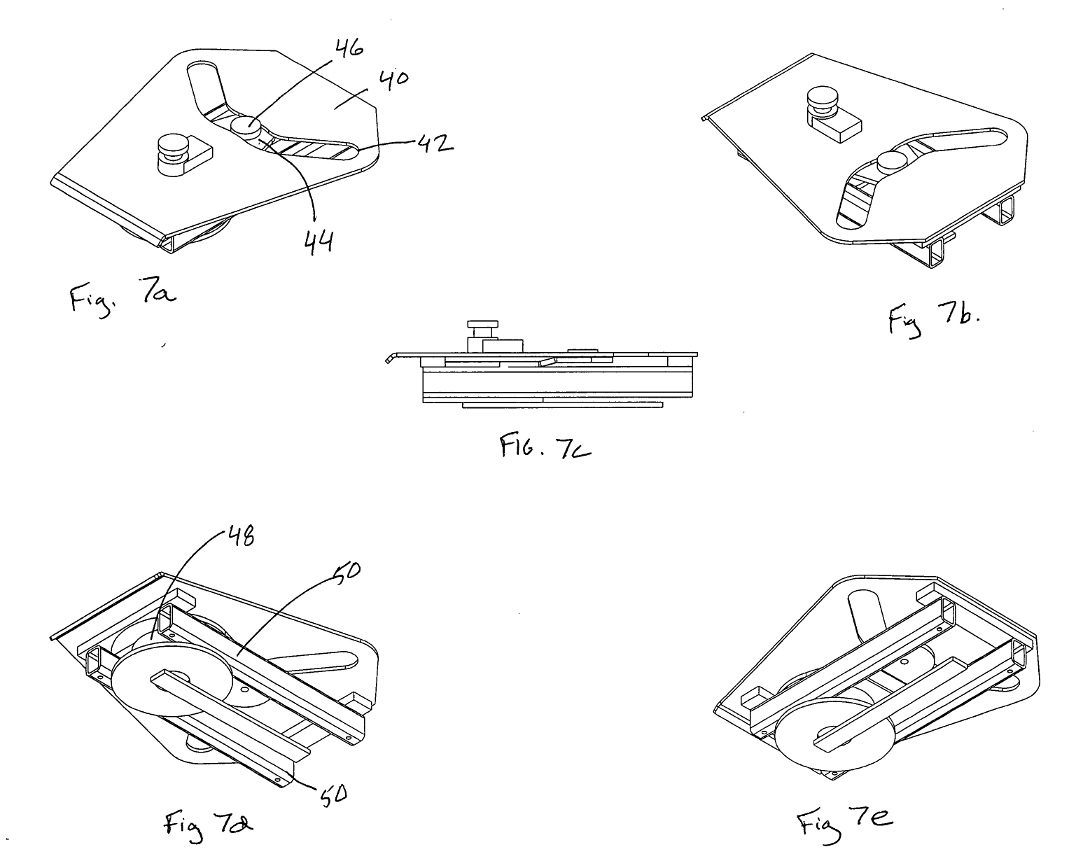

As best shown in FIGS. 7-10, trailer assembly 12 comprises a skid plate 40 having a cam channel 42 therein. A cam arm 44 comprises a plate having a cam member 46 therein wherein the cam arm 44 is connected at one end to the hitch bar 32 and wherein the cam member 46 engages and is moveable within the cam channel 42. Further, the cam arm 44 is connected to a bearing surface 48 that is secured between rail members 50.

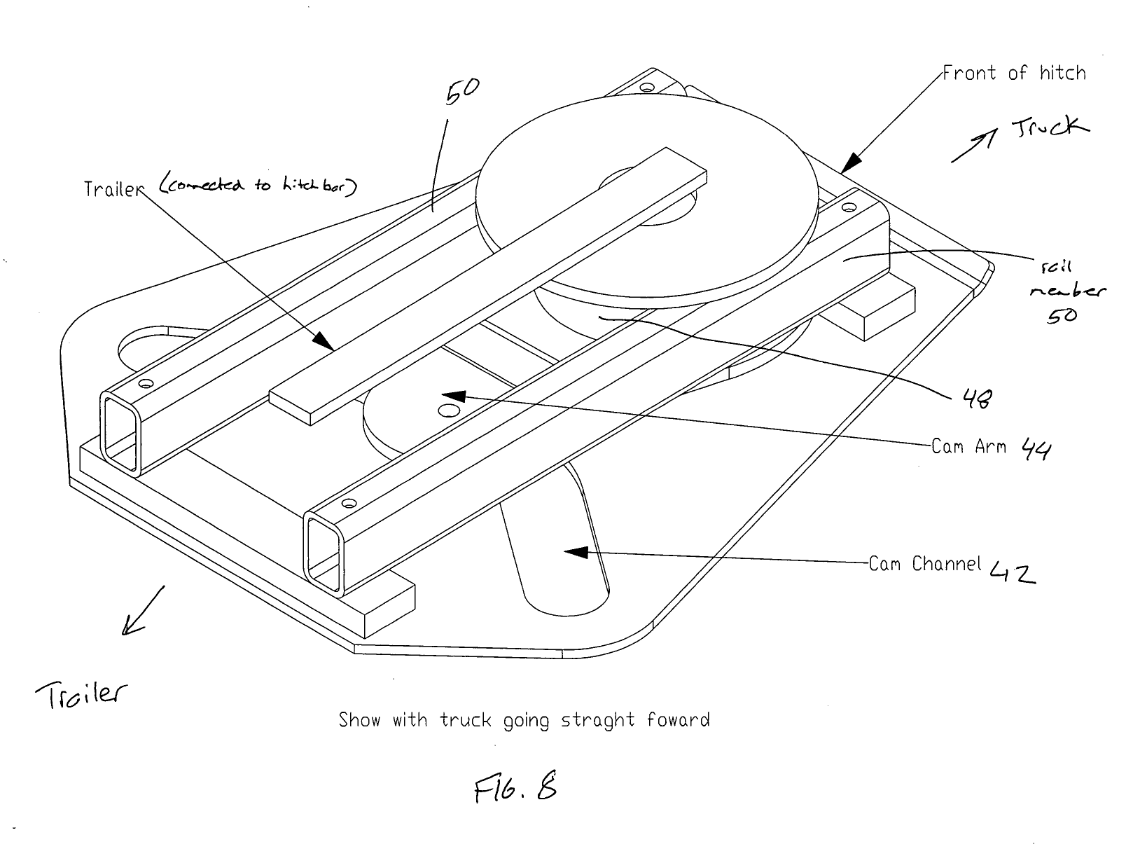

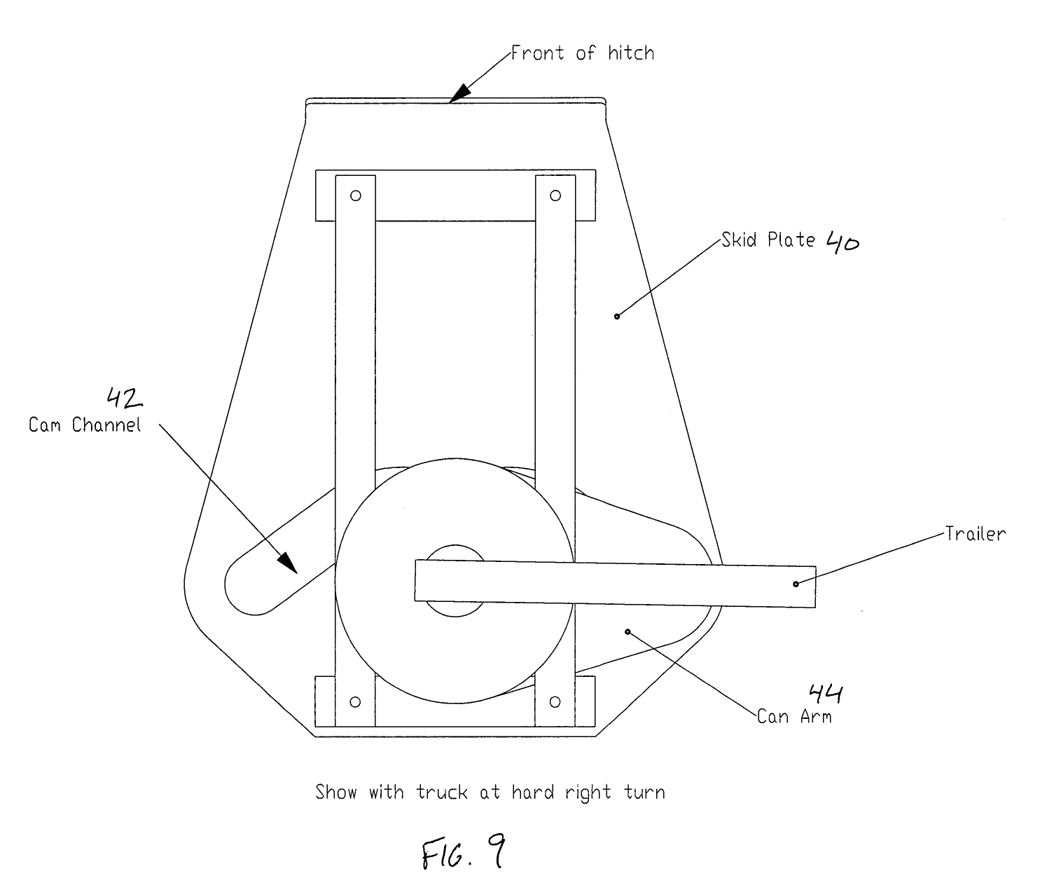

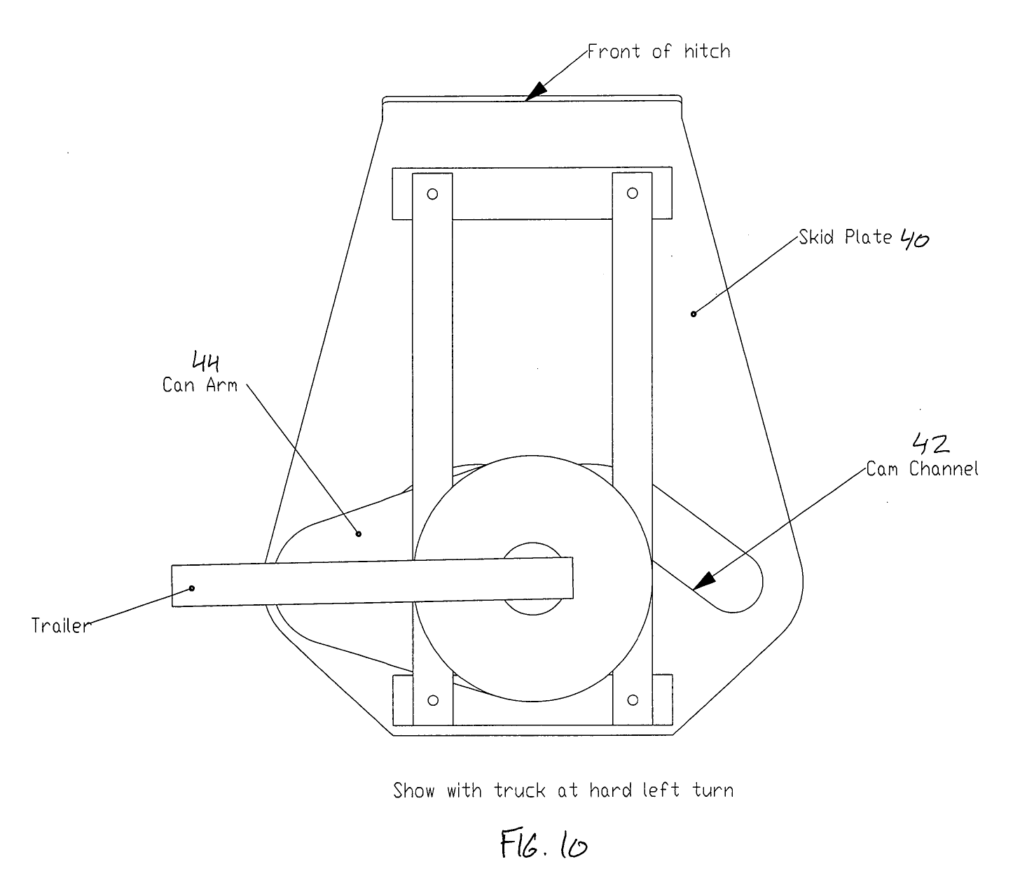

FIG. 8 shows the underside of the trailer assembly 12. Thus, as the truck moves forward, and the trailer assembly 12 pulls the hitch bar 32, the hitch bar 32 pulls the one end of the cam arm 44 which causes the cam member 46 to be positioned as shown in FIG. 8 at approximately the center of the cam channel 42. As the truck turns to the right as shown in FIG. 9, the trailer connection rotates the cam arm 44 so that the cam member 46 is pushed to one end of the cam channel 42 and the bearing surface 48 moves between the rail members 50 toward the opposing end of the cam channel 42. Therefore, the skid plate 40 is permitted to move away from the truck to provide additional clearance between the truck cab and the trailer. When the truck straightens out, the trailer is pulled to thereby pivot to a parallel position with the truck and reverse movement caused by the right hand turn. Thus the trailer assembly 12 moves back to the position as shown in FIG. 8. Based upon this description, the movements of trailer assembly 12 should be readily understood based upon a truck cab taking a left turn as shown in FIG. 10.

Therefore, the present invention overcomes the disadvantages of the prior art by providing the sliding movement in the fifth wheel trailer assembly thereby allowing the fifth wheel hitch assembly to be stationarily mounted within the pickup bed. As such, the most efficient or appropriate position for the fifth wheel hitch assembly can be determined and utilized so as to provide greater accommodation of the weight thereon by supporting the entire weight of the fifth wheel trailer at that point even during automatic adjustment.

Having thus described the invention, we claim:

1. A fifth wheel assembly for coupling a trailer to a towing vehicle comprising:
a hitch assembly having a base, said base connectable to said towing vehicle; and
a trailer assembly pivotally coupled to said base of said hitch assembly, said trailer assembly connectable to the trailer wherein said trailer assembly is slidable in a longitudinal direction with respect to said hitch assembly such that the trailer is movable toward and away from the towing vehicle.

2. The fifth wheel assembly of claim 1 further comprising:
a rocker pivotally connected to said base, said rocker pivotable in a side to side direction with respect to the base;

3. The fifth wheel assembly of claim 1 further comprising:
arched legs extending from the base, said legs shaped to support said base.

4. The fifth wheel assembly of claim 3 wherein said arched legs have a radius of curvature of about sixty to ninety degrees.

5. The fifth wheel assembly of claim 1 further comprising:
a hitch bar connecting said trailer assembly to said hitch assembly, wherein said trailer assembly is slidable with respect to said hitch bar.

6. The fifth wheel assembly of claim 5 further comprising:
a cam arm connected to said hitch bar wherein the hitch bar pulls said cam arm upon movement of the towing vehicle.

7. A self-adjusting fifth wheel assembly for coupling a trailer to a transporting vehicle comprising:
a skid plate connectable to said trailer;
a hitch assembly having a base connectable to said skid plate and mountable to said transporting vehicle; and
a hitch bar pivotally connecting said hitch assembly to said skid plate, said skid plate movable in a direction away from the transporting vehicle.

8. The self-adjusting fifth wheel assembly of claim 7 comprising:
a cam channel formed in said skid plate.

9. The self-adjusting fifth wheel assembly of claim 8 comprising:
a cam arm connected to the hitch bar wherein said cam arm is movable with respect to the cam channel.

10. The self-adjusting fifth wheel assembly of claim 9 wherein said cam arm has a cam member integrally formed at an end of the cam arm and further wherein said cam member is movable within said cam channel.

11. The self-adjusting fifth wheel assembly of claim 7 comprising:
a rocker pivotally connected to said base of said hitch assembly wherein the rocker pivots from side to side with respect to the base.

12. The self-adjusting fifth wheel assembly of claim 7 further comprising:
legs attached to the base of the hitch assembly wherein the legs have a radius of curvature of between forty-five and ninety degrees.

13. The self-adjusting fifth wheel assembly of claim 10 wherein said cam arm is movable toward an end of the cam channel upon turning movement of said transporting vehicle.

14. The self-adjusting fifth wheel assembly of claim 10 wherein said cam member is movable to a central position within said cam channel during longitudinal movement of said transporting vehicle and movable to an end of said cam channel during lateral movement of said transporting vehicle.

15. A self-adjusting fifth wheel assembly for coupling a trailer to a transporting vehicle, said fifth wheel assembly comprising:
a trailer assembly comprising:
a skid plate having a cam channel formed in said skid plate;
a cam arm having a cam member wherein the cam member engages and is movable within said cam channel; and
a hitch assembly pivotally connectable to said trailer assembly, said hitch assembly comprising:
a base attachable to a transporting vehicle; and
a rocker pivotally connected to said base, said trailer assembly is movable in a with respect to said hitch assembly such that the trailer is movable toward and away from the towing vehicle.

16. The fifth wheel assembly of claim 15 further comprising:
a hitch bar pivotally connecting said trailer assembly to said hitch assembly.

17. The fifth wheel assembly of claim 15 wherein the rocker is pivotable in a side to side direction with respect to said base of said hitch assembly.

18. The fifth wheel assembly of claim 15 further comprising:
legs connected to said base, wherein said legs have a radius of curvature of between forty-five and ninety degrees.

19. The fifth wheel assembly of claim 16 wherein the hitch bar pulls the cam arm causing the cam member to move within the cam channel.

20. The fifth wheel assembly of claim 16 wherein the cam member moves from a center position toward an end of the cam channel to move the trailer away from the transporting vehicle.
